(19) United States
(12) Patent Application Publication
(10) Pub. No.: US 2023/0364596 A1
(43) Pub. Date: Nov. 16, 2023

(54) CATALYST SUBSTRATE COMPRISING MAGNETIC MATERIAL ADAPTED FOR INDUCTIVE HEATING

(71) Applicant: BASF Corporation, Florham Park, NJ (US)

(72) Inventors: Matthew T. Caudle, Iselin, NJ (US); Xiaofan Yang, Iselin, NJ (US); Michel Deeba, East Brunswick, NJ (US)

(21) Appl. No.: 18/029,840

(22) PCT Filed: Oct. 1, 2021
(86) PCT No.: PCT/US2021/053083

§ 371 Date: Mar. 31, 2023

Related U.S. Application Data
(60) Provisional application No. 63/087,640, filed on Oct. 5, 2020.

(51) Int. Cl. B01J 35/00; B01J 35/04; B01J 23/80; B01J 21/04; B01J 35/02; B01J 37/04; B01J 37/03; B01J 37/00; B01D 53/94; F01N 3/20; F01N 3/28; F01N 3/10

(52) U.S. Cl. CPC B01J 35/0033; B01J 35/04; B01J 35/0006; B01J 23/80; B01J 21/04; B01J 35/023; B01J 37/04; B01J 37/038; B01J 37/0036; B01D 53/9495; F01N 3/2013; F01N 3/2828; F01N 3/2066; F01N 3/101; B01D 2255/9155; B01D 2258/012; F01N 2330/06; F01N 2370/04; F01N 2510/068; F01N 2510/063; F01N 2240/05

(57) ABSTRACT

The present disclosure provides a catalyst substrate, including: a) a ceramic material and b) a magnetic material, wherein the magnetic material is capable of inductive heating in response to an applied alternating magnetic field. The magnetic material can be associated with the ceramic material in various ways (e.g., dispersed within at least a portion of the ceramic material or contained within pores of the ceramic material). The disclosure further provides a catalyst article including such a catalyst substrate and at least one catalytic washcoat layer deposited thereon. The catalyst article can be adapted for various purposes, depending on the composition of the catalytic washcoat. The disclosure also includes a system and method for heating a catalyst material, which includes the catalyst article and a conductor for receiving current and generating an alternating electromagnetic field in response thereto.

This application claims the benefit of priority of U.S. Provisional Application No. 63/087,640, filed Oct. 5, 2020, the contents of which are incorporated by reference herein in their entirety.

The present disclosure relates to catalyst substrates that can be coated with various catalyst compositions, providing articles for use in treating engine effluent, methods for the preparation and use of such catalyst substrates and articles, and systems employing such catalyst substrates and articles.

Emissions of diesel engines include particulate matter (PM), nitrogen oxides (NOₓ), unburned hydrocarbons (HC), and carbon monoxide (CO). NOₓ is a term used to describe various chemical species of nitrogen oxides, including nitrogen monoxide (NO) and nitrogen dioxide (NO₂), among others. The two major components of exhaust particulate matter are the soluble organic fraction (SOF) and the soot fraction. The SOF condenses on the soot in layers, and is generally derived from unburned diesel fuel and lubricating oils. The SOF can exist in diesel exhaust either as a vapor or as an aerosol (i.e., fine droplets of liquid condensate), depending on the temperature of the exhaust gas. Soot is predominately composed of particles of carbon. The HC content of exhaust can vary depending on engine type and operating parameters, but typically includes a variety of short-chain hydrocarbons such as methane, ethane, propane, and the like, as well as longer-chain fuel-based hydrocarbons.

Catalysts used to treat the exhaust of internal combustion engines are less effective during periods of relatively low temperature operation, such as the initial cold-start period of engine operation, because the engine exhaust is not at a temperature sufficiently high for efficient catalytic conversion to occur. This is particularly true for the downstream catalyst components, such as those placed after a high-thermal mass filter, such as an SCR catalyst, which can take several minutes to reach a suitable operating temperature.

Use of on-board, electric power to heat a catalyst article during start-up conditions has been suggested. Various methods include, e.g., preheating gas via resistive heating of a heating element (see, e.g., U.S. Pat. No. 8,479,496 to Gonze et al.; U.S. Pat. No. 10,690,031 to Barrientos Betancourt et al.; U.S. Pat. No. 6,112,519 to Shimasaki et al.; and U.S. Pat. No. 8,156,737 to Gonze et al.); direct resistive heating of a catalyst substrate (see, e.g., US Pat. App. Publ. No. US2011/0072805 and U.S. Pat. No. 10,677,127 to Achenbach et al.); and resistive heating of conductive elements in a ceramic substrate (see, e.g., U.S. Pat. No. 10,731,534 to Stiglmair et al.; U.S. Pat. No. 10,681,779 to Noro; U.S. Pat. No. 9,845,714 to Mori et al., U.S. Pat. No. 8,784,741 to Yoshioka et al., and U.S. Pat. No. 8,329,110 to Kinoshita et al.). In a typical approach, the heat is generated by the electric heater, e.g., electric wires wrapped outside the catalyst substrate, a heated grid, or a metallic substrate itself serving as the heating element. Several challenges to successful commercialization of such systems exist, including the relatively high energy consumption required and the relatively low heating efficiency due to the need to first heat the catalyst substrate. In addition, most electric heating designs in the art use metallic substrates and are not compatible with the more widely-adopted ceramic substrates used as a catalyst carrier in many systems. Various engine management strategies have also been suggested to address decreased efficiency during the initial cold-start period (see, e.g., U.S. Pat. No. 10,138,781 to Host et al.; U.S. Pat. No. 10,082,047 to Joshi et al.; U.S. Pat. No. 9,506,426 to Remes; U.S. Pat. No. 10,273,906 to McQuillen et al.; U.S. Pat. No. 6,657,315 to Peters et al.; U.S. Pat. No. 8,955,473 to Zhang; and U.S. Pat. No. 9,382,857 to Glugla et al.).

Induction heating of catalyst bodies has been explored (see, e.g., U.S. Pat. Nos. 9,488,085; 10,132,221; and U.S. Pat. No. 10,352,214 to Crawford and Douglas). Current technology employs electrically conductive elements embedded in a ceramic substrate, which are heated by induction of eddy currents in the conductor. Non-contact induction heating of catalysts has several advantages. There is no need for a direct electrical connection to the catalyst body. The incorporate a ceramic support for the catalyst washcoat. But the current technology suffers from complexity in manufacture (e.g., melding ceramic/metallic interfaces) and inhomogeneity in the distribution of heat.

There is a continuing need in the art to reduce tailpipe emissions of gaseous pollutants from gasoline or diesel engines, such as breakthrough emissions that occur during cold start of the engine or during other low-temperature operation points.

The present disclosure provides a catalyst substrate comprising a base material (e.g., a ceramic material) and a magnetic material capable of inductive heating in response to an applied alternating electromagnetic field. The disclosed subject matter can be used to provide heating of the catalyst substrate, which in turn can provide heating of one or more catalyst washcoat layers that can be coated thereon to improve efficiency of catalytic activity, such as at times in which conventional catalyst systems require several minutes to reach an operating temperature conducive to catalytic activity, such as during cold-start of an engine. Although the form of the magnetic material can vary, in some embodiments, the magnetic material is in a particulate form that is readily dispersible within ceramic precursor material used to form the catalyst substrate or in a form that can be readily distributed within pores of a catalyst substrate, e.g., after formation of the substrate.

In some embodiments, a catalyst substrate is provided, wherein the substrate comprises: a) a ceramic material and b) a magnetic material, and wherein the magnetic material is capable of inductive heating in response to an applied alternating magnetic field. In some embodiments, a catalyst article is provided, comprising a catalytic washcoat on the catalyst substrate referenced herein.

The magnetic material can be associated with the catalyst substrate in various ways. For example, at least a portion (such as, substantially all) of the magnetic material of the catalyst substrate is contained within the substrate. For example, in some embodiments, the magnetic material is dispersed within the ceramic material. In some embodiments, the magnetic material is contained within pores of the ceramic material.

The composition of the magnetic material is not particularly limited, so long as the material can be suitably heated, e.g., via the application of an applied alternating magnetic field. In some embodiments, the magnetic material comprises an electrically insulating material. In some embodiments, the magnetic material comprises one or more metal oxides. Such metal oxides, in some embodiments, are chosen from transition metal oxides and rare earth metal oxides. Non-limiting examples of such metal oxides include one or more of oxides of lanthanum, cerium, neodymium, gadolinium, yttrium, praseodymium, samarium, hafnium, tungsten, manganese, iron, cobalt, nickel, copper, and zinc. In some embodiments, the magnetic material is in particulate form. The size of the particles can vary and may be somewhat limited, e.g., by the configuration of the substrate (e.g., wall thickness). For example, the magnetic material can be in the form of particles with average diameters of about 20 nm or greater, about 25 nm or greater, or about 30 nm or greater. In some embodiments, the particles are small enough to enter pores within the substrate (which can be, e.g., in the micron size range). As such, particles can, in some such embodiments, be less than about 1000 nm, less than about 800 nm, less than about 600 nm, less than about 500 nm, less than about 300 nm, less than about 200 nm, or less than about 100 nm.

The ceramic material of the catalyst substrate, in some embodiments, comprises one or more cordierite, silicon carbide, or aluminum titanate. In some embodiments, the magnetic material is located substantially uniformly throughout the catalyst substrate. In some embodiments, the magnetic material is more concentrated in one or more particular regions within the catalyst substrate. For example, in some embodiments, the catalyst substrate is cylindrical with a radial center and a radial edge, and the magnetic material is more concentrated at the radial center than at the radial edge or the magnetic material is more concentrated at the radial edge than at the radial center. In some embodiments, the catalyst substrate comprises an inlet end and an outlet and, and the magnetic material is more concentrated at the inlet end than at the outlet end or is more concentrated at the outlet end than at the inlet end.

The catalyst substrate is, for example, in some embodiments, a monolithic flow-through substrate having a plurality of parallel gas passages that are open to fluid flow. As another example, the catalyst substrate is a wall-flow substrate having a first and second end, and having a plurality of parallel gas passages, wherein a portion of the plurality of parallel gas passages are blocked at the first end and open at the second end and an alternate portion of the plurality of parallel gas passages are open at the first end and blocked at the second end.

Catalytic washcoats that can suitably be used on the catalytic substrates provided herein can vary widely, depending e.g., upon the desired function of the resulting catalyst article. In some embodiments, the catalytic washcoat comprises a catalytic material adapted for one or more of oxidation of carbon monoxide, oxidation of hydrocarbons, oxidation of NOₓ, reduction of NOₓ, oxidation of ammonia, selective catalytic reduction of NOₓ, NOₓ storage/reduction, oxygen storage, soot burning or oxidation, and water-gas-shift. The catalyst article can be adapted, for example, for use as a diesel oxidation catalyst (DOC), a catalyzed soot filter (CSF), a lean NOₓ trap (LNT), a selective catalytic reduction (SCR) catalyst, an SCR catalyst on filter (SCRoF), an ammonia oxidation (AMOₓ) catalyst, a NOₓ absorber, or a three-way catalyst (TWC).

The disclosure further provides, in some embodiments, a system comprising a catalyst article as described herein (comprising a ceramic material and a magnetic material, wherein the magnetic material is capable of inductive heating in response to an applied alternating magnetic field), and a conductor for receiving current and generating an alternating electromagnetic field in response thereto, and the conductor is positioned wherein the generated alternating electromagnetic field is applied to at least a portion of the magnetic material. In some embodiments, the conductor is in a form of at least one coil of conductive wire surrounding at least a portion of the catalyst article. The system can, in some embodiments, further comprise an electric power source electrically connected to the conductor for supplying alternating current thereto. The system can, in some embodiments, further comprise a temperature sensor positioned to measure the temperature of gases entering the catalyst article and a controller in communication with the temperature sensor, wherein the controller is adapted for control of the current received by the conductor such that the controller can energize the conductor with current when inductive heating of the catalyst substrate is desired.

The disclosure additionally provides a method of treating emissions from an internal combustion engine, comprising: treating exhaust gas produced from an internal combustion engine with an emission treatment system comprising a catalyst article as described herein (comprising a ceramic material and a magnetic material, wherein the magnetic material is capable of inductive heating in response to an applied alternating magnetic field) in fluid communication with the engine. The engine can, in some embodiments, is a gasoline engine, diesel engine, hybrid electric, or natural gas engine.

These and other features, aspects, and advantages of the disclosure will be apparent from a reading of the following detailed description together with the accompanying drawings, which are briefly described below. The disclosed subject matter comprises any combination of two, three, four, or more of the above-noted embodiments as well as combinations of any two, three, four, or more features or elements set forth in this disclosure, regardless of whether such features or elements are expressly combined in a specific embodiment description herein. This disclosure is intended to be read holistically such that any separable features or elements of the disclosed subject matter, in any of its various aspects and embodiments, should be viewed as intended to be combinable unless the context clearly dictates otherwise. Other aspects and advantages of the present disclosure will become apparent from the following.

### BRIEF DESCRIPTION OF THE DRAWINGS

To provide an understanding of embodiments of the disclosure, reference is made to the appended drawings, which are not necessarily drawn to scale, and in which reference numerals refer to components of exemplary embodiments of the disclosure. The drawings are exemplary only and should not be construed as limiting the disclosure.

FIG. 1A is a partial cross-sectional view of a catalyst substrate perpendicular to the channel direction showing the channel opening 10, the substrate wall 12, and magnetic particles 20 dispersed in the wall;

FIG. 1B is a partial cross-sectional view of a catalyst substrate perpendicular to the channel direction showing the channel opening 10, the substrate wall 12, and magnetic particles 20 dispersed in pores of the substrate material:

FIGS. 2A and 2B are depictions of embodiments of the disclosed magnetic material-containing substrate, with longitudinal magnetic material distribution;

FIG. 3 is a depiction of an embodiment of the disclosed magnetic material-containing substrate, with radial magnetic material distribution;

FIG. 4A is a perspective view of a honeycomb-type catalyst 2 with inlet end 6 and outlet end 8, and channels 10, which may comprise a substrate in accordance with the present disclosure, comprising a magnetic material within the substrate;

FIG. 4B is a partial cross-sectional view of 2 enlarged relative to FIG. 4A and taken along a plane parallel to the end faces of 2 of FIG. 4A, which shows an enlarged view of a plurality of the gas flow passages 10 shown in FIG. 4A, with walls 12 and washcoat layers 14 and 16;

FIG. 5 is a cutaway view of a section enlarged relative to FIG. 4A, wherein the honeycomb-type substrate carrier in FIG. 4A represents a wall flow filter substrate monolith:

FIG. 6 shows a schematic depiction of an embodiment of an emission treatment system 40, comprising an internal combustion engine 42, a diesel oxidation catalyst 44, a catalyzed soot filter 46, and a selective catalytic reduction catalyst 48, which are in fluid communication with each other by 43, 45 and 47, and in which a catalyst article of the present disclosure is utilized:

FIG. 7 is a schematic depiction of one configuration wherein a catalyst article 2 of the present disclosure is utilized, and which illustrates an electrical conductor 66, controller 74, power source 70, and temperature sensor 72;

FIG. 8 is a schematic depiction of an embodiment of an emission treatment system 51 in which more than one catalyst article of the present disclosure is utilized, and which illustrates associated electrical conductors, controllers, power sources, and temperature sensors;

FIG. 9A is a low-magnification scanning electron microscope image of Example 1 in cross-section perpendicular to the channel axis (where black areas indicate the channel and void space, gray areas indicate cordierite in the substrate walls, and white areas indicate magnetic particles);

FIG. 9B is a high-magnification scanning electron microscope image of Example 1 in cross-section perpendicular to the channel axis (where black areas indicate the channel and void space, gray areas indicate cordierite in the substrate walls, and white areas indicate magnetic particles);

FIG. 10A is a low-magnification scanning electron microscope image of Example 2 in cross-section perpendicular to the channel axis (where black areas indicate the channel and void space, gray areas indicate cordierite in the substrate walls, and white areas indicate magnetic particles);

FIG. 10B is a high-magnification scanning electron microscope image of Example 2 in cross-section perpendicular to the channel axis (where black areas indicate the channel and void space, gray areas indicate cordierite in the substrate walls, and white areas indicate magnetic particles);

FIG. 11 is a chart showing the temperature as a function of time when a magnetically activated ceramic substrate is exposed to an alternating magnetic field generated by an AC potential applied to a wire coil surrounding the part (where the control data was generated using a standard ceramic substrate without magnetic activation):

FIG. 12 is a sequence of infrared thermal images collected every 30 seconds while a magnetically activated ceramic substrate is exposed to an alternating magnetic field generated by an AC potential applied to a wire coil surrounding the part; and

FIGS. 13A and 13B are infrared thermal images collected when a conductive metal substrate is exposed to an alternating magnetic field generated by an AC potential applied to a wire coil surrounding the part.

The present disclosure now will be described more fully hereinafter. Although the disclosure herein has been described with reference to particular embodiments, it is to be understood that these embodiments are merely illustrative of the principles and applications of the present disclosure. It will be apparent to those skilled in the art that various modifications and variations can be made to the method and apparatus of the present subject matter without departing from the spirit and scope of the disclosure. Thus, it is intended that the present disclosure include modifications and variations that are within the scope of the appended claims and their equivalents. It is to be understood that the disclosure is not limited to the details of construction or process steps set forth in the following description. The disclosure is capable of other embodiments and of being practiced or being carried out in various ways. Like numbers refer to like elements throughout. As used in this specification and the claims, the singular forms “a,” “an,” and “the” include plural referents unless the context clearly dictates otherwise.

The present disclosure generally relates to catalytic articles comprising a substrate and one or more catalyst compositions in the form of washcoat layers thereon. The substrate typically provides a plurality of wall surfaces upon which the catalyst composition is applied and adhered, thereby acting as a carrier for the catalyst composition. The substrate can be of the type typically used for preparing automotive catalysts and will typically comprise a metal or ceramic honeycomb structure. Both the substrate and the catalyst composition(s) will be described in further detail herein below.

### Definitions

The articles “a” and “an” herein refer to one or to more than one (e.g. at least one) of the grammatical object. Any ranges cited herein are inclusive. The term “about” used throughout is used to describe and account for small fluctuations. For instance, “about” may mean the numeric value may be modified by ±5%, ±4%, ±3%, ±2%, ±1%, ±0.5%, ±0.4%, ±0.3%, ±0.2%, ±0.1% or ±0.05%. All numeric values are modified by the term “about” whether or not explicitly indicated. Numeric values modified by the term “about” include the specific identified value. For example “about 5.0” includes 5.0.

The term “abatement” means a decrease in the amount, caused by any means.

“AMOₓ” refers to a selective ammonia oxidation catalyst, which is a catalyst comprising one or more metals (typically Pt, although not limited thereto) and selective catalytic reduction (SCR) catalyst suitable to convert ammonia to nitrogen.

The term “associated” means for instance “equipped with”, “connected to” or in “communication with”, for example “electrically connected” or in “fluid communication with” or otherwise connected in a way to perform a function. The term “associated” may mean directly associated with or indirectly associated with, for instance through one or more other articles or elements.

“Average particle size” is synonymous with D50, meaning half of the population of particles has a particle size above this point, and half below. Particle size refers to primary particles. Particle size may be measured by laser light scattering techniques, with dispersions or dry powders, for example according to ASTM method D4464. D90 particle size distribution indicates that 90% of the particles (by number) have a Feret diameter below a certain size as measured by Scanning Electron Microscopy (SEM) or Transmission Electron Microscopy (TEM) for submicron size particles; and a particle size analyzer for the support-containing particles (micron size).

The term “catalyst” refers to a material that promotes a chemical reaction. The catalyst includes the “catalytically active species” and the “support” that carries or supports the active species. For example, zeolites are supports for palladium active catalytic species. Likewise, refractory metal oxide particles may be a support for platinum group metal catalytic species. The catalytically active species are also termed “promoters” as they promote chemical reactions. For example, a present palladium-containing rare earth metal component may be termed a Pd-promoted rare earth metal component. A “promoted rare earth metal component” refers to a rare earth metal component to which catalytically active species are intentionally added.

The term “catalytic article” in the disclosed subject matter means an article comprising a substrate having a catalyst coating composition.

The term “configured” as used in the description and claims is intended to be an open-ended term as are the terms “comprising” or “containing.” The term “configured” is not meant to exclude other possible articles or elements. The term “configured” may be equivalent to “adapted.”

“CSF” refers to a catalyzed soot filter, which is a wall-flow monolith. A wall-flow filter consists of alternating inlet channels and outlet channels, where the inlet channels are plugged on the outlet end and the outlet channels are plugged on the inlet end. A soot-carrying exhaust gas stream entering the inlet channels is forced to pass through the filter walls before exiting from the outlet channels. In addition to soot filtration and regeneration, A CSF may carry oxidation catalysts to oxidize CO and HC to CO₂ and H₂O. or oxidize NO to NO₂ to accelerate the downstream SCR catalysis or to facilitate the oxidation of soot particles at lower temperatures. An SCR catalyst composition can also coated directly onto a wall-flow filter, which is called SCRoF.

“DOC” refers to a diesel oxidation catalyst, which converts hydrocarbons and carbon monoxide in the exhaust gas of a diesel engine. Typically, a DOC comprises one or more platinum group metals such as palladium and/or platinum; a support material such as alumina; a zeolite for HC storage; and optionally, promoters and/or stabilizers.

As used herein, the phrase “emission treatment system” refers to a combination of two or more catalyst components, for example, a combination of an LNT-LT-NA as disclosed herein and one or more additional catalyst components which may be, for example, a CSF, a DOC, or a selective catalytic reduction (SCR) catalytic article.

In general, the term “effective” means for example from about 35% to 100% effective, for instance from about 40%, about 45%, about 50% or about 55% to about 60%, about 65%, about 70%, about 75%, about 80%, about 85%, about 90% or about 95%, regarding the defined catalytic activity or storage/release activity, by weight or by moles.

The term “exhaust stream” or “exhaust gas stream” refers to any combination of flowing gas that may contain solid or liquid particulate matter. The stream comprises gaseous components and is for example exhaust of a lean burn engine, which may contain certain non-gaseous components such as liquid droplets, solid particulates and the like. The exhaust gas stream of a combustion engine typically further comprises combustion products (CO₂ and H₂O), products of incomplete combustion (carbon monoxide (CO) and hydrocarbons (HC)), oxides of nitrogen (NOₓ), combustible and/or carbonaceous particulate matter (soot), and un-reacted oxygen and nitrogen. As used herein, the terms “upstream” and “downstream” refer to relative directions according to the flow of an engine exhaust gas stream from an engine towards a tailpipe, with the engine in an upstream location and the tailpipe and any pollution abatement articles such as filters and catalysts being downstream from the engine. The inlet end of a substrate is synonymous with the “upstream” end or “front” end. The outlet end is synonymous with the “downstream” end or “rear” end. An upstream zone is upstream of a downstream zone. An upstream zone may be closer to the engine or manifold, and a downstream zone may be further away from the engine or manifold.

The term “in fluid communication” is used to refer to articles positioned on the same exhaust line, i.e., a common exhaust stream passes through articles that are in fluid communication with each other. Articles in fluid communication may be adjacent to each other in the exhaust line. Alternatively, articles in fluid communication may be separated by one or more articles, also referred to as “washcoated monoliths.”

The term “functional article” in the disclosed subject matter means an article comprising a substrate having a functional coating composition disposed thereon, such as a catalyst and/or sorbent coating composition.

As used herein, “impregnated” or “impregnation” refers to permeation of the catalytic material into the porous structure of the support material.

The terms “on” and “over” in reference to a coating layer may be used synonymously. The term “directly on” means in direct contact with. The disclosed articles are referred to in some embodiments as comprising one coating layer “on” a second coating layer, and such language is intended to encompass embodiments with intervening layers, where direct contact between the coating layers is not required (i.e., “on” is not equated with “directly on”).

As used herein, the term “promoted” refers to a component that is intentionally added to the rare earth metal component, as opposed to impurities inherent in the rare earth metal component. “Promoters” are metals that enhance activity toward a desired chemical reaction or function.

As used herein, the term “selective catalytic reduction” (SCR) refers to the catalytic process of reducing oxides of nitrogen to dinitrogen (N₂) using a nitrogenous reductant.

As used herein, the terms “nitrogen oxides” or “NOₓ” designate the oxides of nitrogen, such as NO, NO₂ or N₂O.

As used herein, the term “stream” broadly refers to any combination of flowing gas that may contain solid or liquid particulate matter. The term “gaseous stream” or “exhaust gas stream” means a stream of gaseous constituents, such as the exhaust of a combustion engine, which may contain entrained non-gaseous components such as liquid droplets, solid particulates, and the like. The exhaust gas stream of a combustion engine typically further comprises combustion products (CO₂ and H₂O), products of incomplete combustion (carbon monoxide (CO) and hydrocarbons (HC)), oxides of nitrogen (NOₓ), combustible and/or carbonaceous particulate matter (soot), and un-reacted oxygen and nitrogen.

“Substantially free” means “little or no” or “no intentionally added” and also having only trace and/or inadvertent amounts. For instance, in some embodiments, “substantially free” means less than 2 wt. % (weight %), less than 1.5 wt. %, less than 1.0 wt. %, less than 0.5 wt. %, 0.25 wt. % or less than 0.01 wt. %, based on the weight of the indicated total composition.

As used herein, the term “substrate” refers to the monolithic material onto which the catalyst composition, that is, catalytic coating, is disposed, typically in the form of a washcoat. In one or more embodiments, the substrates are flow-through monoliths and monolithic wall-flow filters. Flow-through and wall-flow substrates are also taught, for example, in International Application Publication No. WO2016/070090, which is incorporated herein by reference. A washcoat is formed by preparing a slurry comprising a specified solids content (e.g., 30-90% by weight) of catalyst in a liquid, which is then coated onto a substrate and dried to provide a washcoat layer. Reference to “monolithic substrate” means a unitary structure that is homogeneous and continuous from inlet to outlet. A washcoat is formed by preparing a slurry comprising a certain solid content (e.g., 20%-90% by weight) of particles in a liquid vehicle, which is then coated onto a substrate and dried to provide a washcoat layer.

As used herein, the terms “upstream” and “downstream” refer to relative directions according to the flow of an engine exhaust gas stream from an engine towards a tailpipe, with the engine in an upstream location and the tailpipe and any pollution abatement articles such as filters and catalysts being downstream from the engine.

As used herein, the term “washcoat” has its usual meaning in the art of a thin, adherent coating of a catalytic or other material applied to a substrate material, such as a honeycomb-type substrate, which is sufficiently porous to permit the passage of the gas stream being treated. As used herein and as described in Heck, Ronald and Farrauto, Robert, Catalytic Air Pollution Control, New York: Wiley-Interscience, 2002, pp. 18-19, a washcoat layer includes a compositionally distinct layer of material disposed on the surface of a monolithic substrate or an underlying washcoat layer. A substrate can contain one or more washcoat layers, and each washcoat layer can be different in some way (e.g., may differ in physical properties thereof such as, for example particle size or crystallite phase) and/or may differ in the chemical catalytic functions.

“Weight percent (wt. %),” if not otherwise indicated, is based on an entire composition free of any volatiles, that is, based on dry solids content. Unless otherwise indicated, all parts and percentages are by weight.

All methods described herein can be performed in any suitable order unless otherwise indicated herein or otherwise clearly contradicted by context. The use of any and all examples, or exemplary language (e.g., “such as”) provided herein, is intended merely to better illuminate the materials and methods and does not pose a limitation on the scope unless otherwise claimed. No language in the specification should be construed as indicating any non-claimed element as essential to the practice of the disclosed materials and methods. All U.S. patent applications, pre-grant publications and patents referred to herein are hereby incorporated by reference in their entireties.

### Substrate

According to the present disclosure, the substrate generally comprises a substrate “base material” and a magnetic material capable of inductive heating in response to an applied alternating electromagnetic field. The use of inductive heating of a magnetic material within the catalyst substrate is a way to direct heat to catalyst material present on the surface of the catalyst substrate (e.g., in the form of a catalyst washcoat) and is able to reach an operating temperature conducive to catalytic activity in a short period of time, such as during cold-start of an engine. By enabling a catalyst material to reach a desired temperature quickly, gaseous pollutant breakthrough normally associated with operation of the catalyst at low temperature can be minimized.

The “base material” can vary and is generally any material from which a substrate can be constructed, which allows for the dispersion of a magnetic material therein (e.g., during the production/formation of the substrate). Some exemplary base materials suitable for use according to the present disclosure are ceramics. Ceramic materials used to construct the substrate may comprise any suitable refractory material, e.g., cordierite, mullite, cordierite-α alumina, silicon nitride, zircon mullite, spodumene, alumina-silica magnesia, zircon silicate, sillimanite, magnesium silicates, zircon, petalite, a alumina, aluminosilicates and the like.

The “magnetic material” can comprise ferromagnetic, ferrimagnetic, and paramagnetic materials. Although the form of the magnetic material can vary, in some embodiments, the magnetic material is in a particulate form that is readily dispersible within a composition comprising base material precursors (e.g., ceramic precursors), from which the substrate is formed. In other embodiments, the magnetic material is in a particulate form that is readily penetrable/impregnatable into pores within an as-formed substrate.

In some embodiments, the size of the particles may directly impact the type of magnetic materials that can be used. In other words, the magnetic particles in some embodiments can generally comprise any material, so long as the particles are above a certain size threshold (suitable to provide the desired effect). In some embodiments, the size of useful particles is limited by substrate dimensions. In some embodiments, the particles must be below a certain threshold (e.g., where introduced within pores of the as-formed substrate, the particles are advantageously below average pore sizes within the substrate). Although the particles can, in some embodiments, be formed at least in part of a conductive material, in some embodiments, particles comprising non-conductive materials (e.g., particles consisting essentially of non-conductive materials) are preferred. In some embodiments, any material that can be inductively coupled via eddy currents (e.g., including metal particles, wire fragments, and other metal-containing materials) can be used for this purpose.

The form (e.g., shape and size) of magnetic material particles can vary. The particles, in some embodiments, are nanoparticles, although they are not limited thereto. As such, in some embodiments, the average particle size is about 100 nm or less (e.g., from about 1 nm to about 100 nm). In some embodiments, the particles are at the smaller end of this range. For example, in some embodiments, the average particle size is about 60 nm or less (e.g., from about 1 nm to about 60 nm), or about 50 nm or less (e.g., from about 1 nm to about 50 nm). In some embodiments, the particles are at the larger end of this range, e.g., about 60 nm or more (e.g., from about 60 nm to about 100 nm or about 80 nm to about 100 nm). In some embodiments, the particles are even larger, e.g., about 100 nm or greater (e.g., from about 100 nm to about 500 nm, from about 100 nm to about 400 nm, from about 100 nm to about 300 nm, from about 100 nm to about 200 nm, or from about 100 nm to about 150 nm). In some embodiments, better heating is provided by larger particles and thus, in such embodiments, the average particle size is about 25 nm or greater. It is noted, as referenced above, that suitable particle sizes may depend on the method of production of a catalyst article as described herein (i.e., whether the particles are added to substrate precursors and directly extruded with the substrate or added post-production of the substrate).

In some embodiments, the particles are substantially monodisperse, although the disclosure is not limited thereto. In some embodiments, the particles may exhibit a bimodal particle size distribution. In some embodiments, the magnetic material comprises nanoparticle magnetic materials denoted as superparamagnetic materials. However, the magnetic material, in some embodiments, can be used in the form of nanowires, nanotubes, or in the form of a sheet so long as the magnetic material is dispersed within the substrate upon production thereof.

Although any material capable of inductive heating in the presence of an alternating electromagnetic field can be used, advantageous magnetic materials include materials comprising a transition metal or a rare earth metal, such as oxides comprising such transition metals or rare earth metals. “Rare earth metal” refers to scandium, yttrium, and the lanthanum series, as defined in the Periodic Table of Elements, or oxides thereof. Examples of rare earth metals comprise lanthanum, cerium, neodymium, gadolinium, yttrium, praseodymium, samarium, hafnium, and mixtures thereof. Examples of transition metals that could be used as a component of the magnetic materials comprise tungsten, manganese, iron, cobalt, nickel, copper, and zinc. Mixtures of transition metals and rare earth metals can be used in the same magnetic material. The oxide forms of many magnetic metals are used in the present disclosure, as metal oxides tend to be highly stable at the operating temperatures often associated with catalyst systems used to treat emissions from engines.

The substrate disclosed herein, comprising both a base material and a magnetic material, can be prepared in various manners. Two examples of methods of preparing such substrates are described in further detail herein below, referred to herein as the “combination” method and the “impregnation” method. Briefly, the combination method comprises extrusion of a composition including both base material precursors and the magnetic material to form a substrate and the impregnation method comprises production of a substrate comprising the base material and impregnation of that substrate with the magnetic material (e.g., such that the magnetic material is introduced into pores within the substrate). These methods are not mutually exclusive, and it is noted that, in some embodiments, a substrate comprising magnetic material is prepared via the combination method and that substrate (comprising the first magnetic material) is then subjected to the impregnation method to introduce a second magnetic material (which can be the same as or different than the first magnetic material). Such a method can, in some embodiments, be advantageous to maximize the amount of magnetic material associated with the substrate.

In some embodiments, a substrate comprising magnetic material is prepared via the combination method as follows. A magnetic material is combined with a composition (e.g., solution or slurry) of base material precursor (e.g., ceramic precursor). The magnetic material is typically (although not always) in the form of particulate material. The combining may comprise mixing, milling, shaking, or the like to promote dispersion of the magnetic material throughout. The resulting mixture is formed into a substrate (e.g., via extrusion or pouring into a mold, followed by calcination and drying). General methods for producing ceramic substrates are known and are described, for example, in U.S. Pat. Nos. 5,314,650; 5,403,787; 6,455,124; 8,673,206; and 9,808,794, all to Corning, Inc., which are incorporated herein by reference in their entireties. The resulting substrate (after being formed appropriately, calcined, and dried) will generally comprise the magnetic material dispersed within the base material. The dispersion may or may not be homogeneous within the base material.

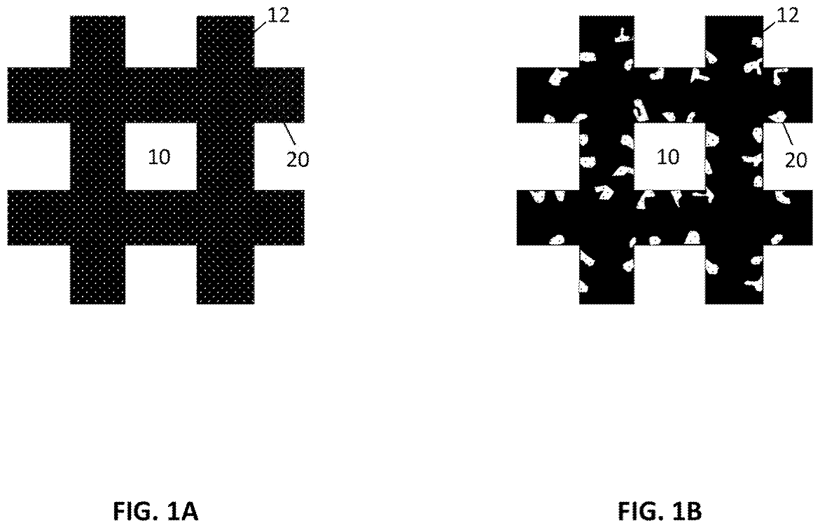

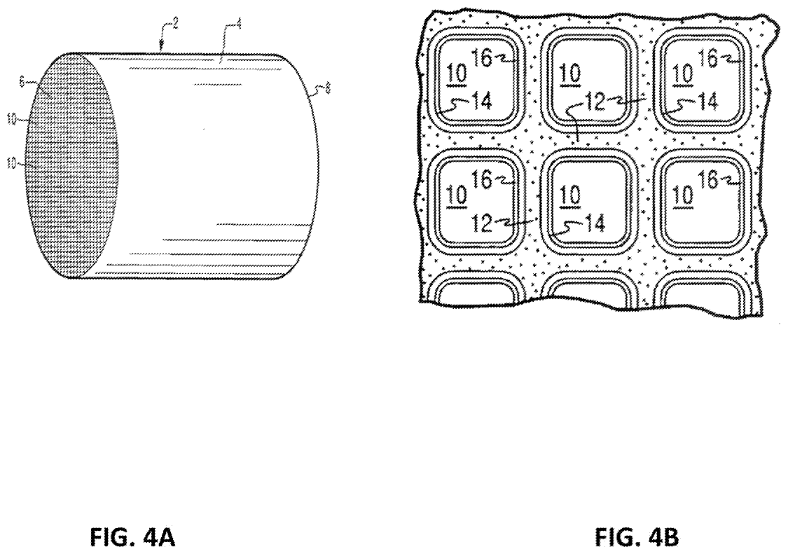

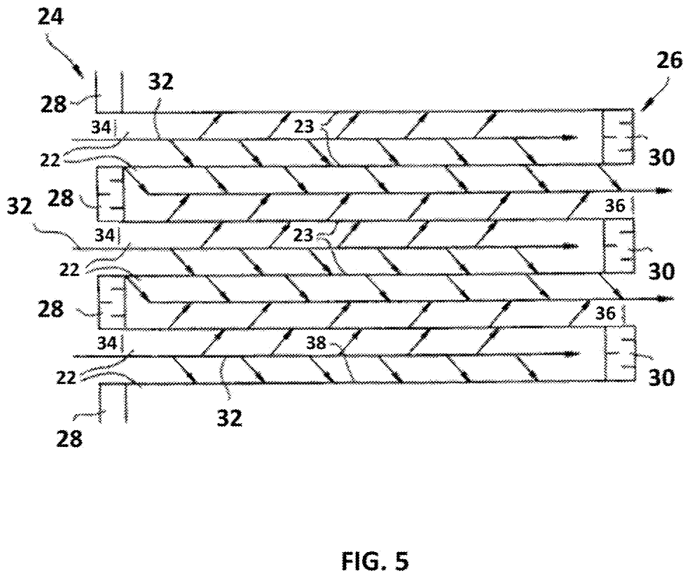

A portion of a substrate cross-section prepared according to one embodiment of the combination method is shown in FIG. 1A, where the black depicts the base material and the w % bite dots represent the magnetic material. In FIG. 1A, the exemplary substrate includes flow passages 10 formed by walls 12 which extend through the substrate from an upstream to downstream end, where the magnetic material 20 is dispersed within the walls 12. This figure can be better understood by reference to FIGS. 4A, 4B, and 5, which depict exemplary catalysts comprising a washcoat composition disposed on a substrate (which can be, e.g., a flow-through substrate or a wall flow filter, as will be described in further detail herein below).

In another embodiment, a substrate comprising magnetic material is prepared via the impregnation method as follows. A substrate comprising a base material is first prepared according to any method known in the art (e.g., extrusion or pouring into a mold etc.), e.g., as outlined in the patents referenced above to Corning, Inc., which are incorporated herein by reference. Separately, a magnetic material is provided and combined with the prepared substrate (before or after the substrate is dried and calcined). The magnetic material can be introduced in various forms, e.g., as a solution, dispersion, suspension, or in solid form. The magnetic material, e.g., penetrates within pores of the substrate such that magnetic material is contained within pores of the substrate. The impregnation process can further comprise shaking, applying pressure, heating, or the like to promote penetration of the magnetic material within the pores. The resulting substrate (after being formed appropriately, calcined, and dried) will generally comprise the magnetic material dispersed within pores of the base material. The dispersion may or may not be homogeneous within the pores.

A portion of a substrate cross-section prepared according to one embodiment of the impregnation method is shown in FIG. 1B, where the black depicts the base material, the white irregular portions indicate pores within the base material, and the black dots within the pores represent the magnetic material. The exemplary substrate includes flow passages 10 formed by walls 12 which extend through the substrate from an upstream to downstream end, where the magnetic material 20 is dispersed within pores in the walls 12. Again, this figure can be better understood by reference to FIGS. 4A, 4B, and 5, which depict exemplary catalysts comprising a washcoat composition disposed on a substrate (which can be, e.g., a flow-through substrate or a wall flow filter, as will be described in further detail herein below).

In some embodiments, the distribution of the magnetic material within the substrate (either within the base material or within pores of the base material) is relatively uniform throughout the entirety of the substrate. Although the present disclosure largely envisions the substantially uniform distribution of magnetic material within the entirety of the substrate, it is noted that, in some embodiments, it may be desirable to incorporate the magnetic material only within a portion of the substrate, such that the substrate comprises a region comprising base material with no added magnetic material and a region comprising base material and added magnetic material. In some embodiments, magnetic material is incorporated both within the substrate/within the pores of the substrate and on the surface of the substrate (e.g., throughout and on the walls of the substrate). In other embodiments, it is incorporated only within the substrate (or substantially only within the substrate/within the pores of the substrate).

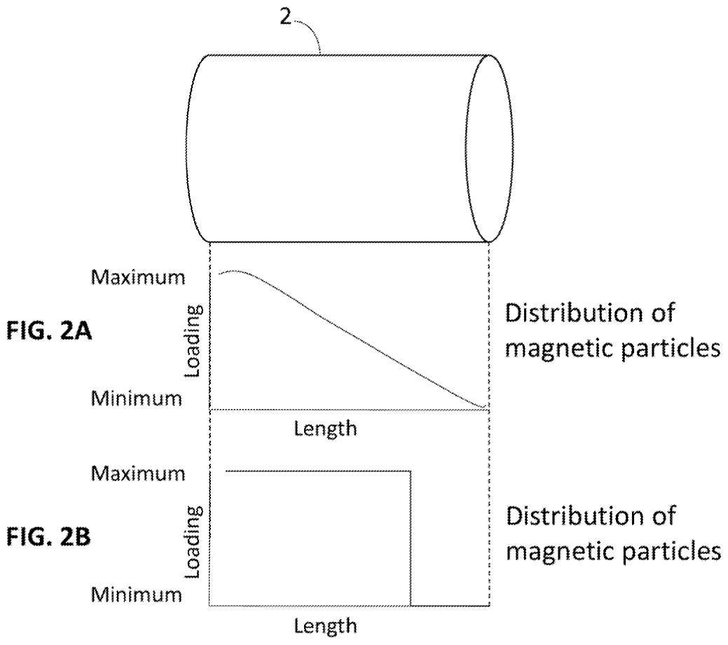

In some embodiments, the concentration of the magnetic material varies throughout the substrate. In some embodiments, the magnetic particles are distributed (within the base material or within pores of the base material) such that a higher concentration is present at the inlet end than the outlet end of the substrate (longitudinal non-uniformity). Two examples of such distribution profiles are shown in FIGS. 2A and 2B, where 2 is the substrate, and the “maximum” amount of magnetic particles is shown at the left of the substrate (understood to be the inlet end) and the “minimum” amount of magnetic particles is shown at the right of the substrate (understood to be the outlet end). The exact shape of the curve/line from maximum to minimum along the length of the substrate in the embodiments of FIGS. 2A and 2B can vary and is not limited to the shape shown. For example, a “maximum” distribution may extend further from the inlet along the length of the substrate than depicted. FIGS. 2A and 2B are provided merely as examples of variability in magnetic material concentration in the longitudinal direction of the substrate. The “maximum” and “minimum” values can vary, and the minimum can be a positive value (i.e., the substrate can comprise some amount of magnetic material in the designated region, which is less than the “maximum”); in other embodiments the “minimum” value is 0 (i.e., the substrate comprises no magnetic particles in the designated region).

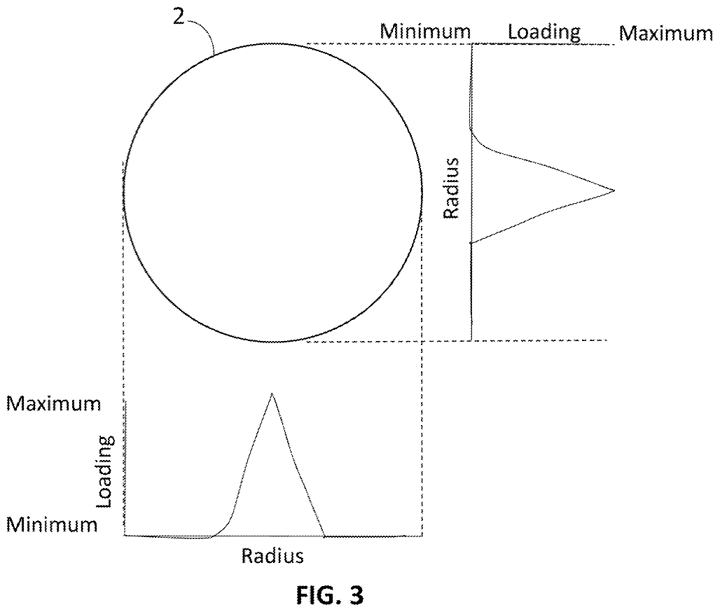

In one some embodiments, the magnetic particles are distributed radially, such that a higher concentration is present at the cross-sectional middle of the substrate than at the exterior of the substrate, as depicted generally in FIG. 3. As shown, the center of the round cross-section of the substrate has the “maximum” concentration, and tapers to the “minimum” concentration at the exterior of the round cross-section (radial non-uniformity). Such a cross-section can be consistent/uniform along the length of the substrate, or can vary as generally described with respect to FIGS. 2A and 2B (i.e., in some embodiments, the loading of magnetic material can vary both longitudinally and radially). Again, FIG. 3 is provided merely as an example of variability in magnetic material concentration in the radial or axial direction of the substrate. The exact change in distribution from the interior of the cross-section to the exterior can vary (e.g., the exact shape of the curve as depicted in FIG. 3 can vary). The “maximum” and “minimum” values can vary, and the minimum can be a positive value (i.e., the substrate can comprise some amount of magnetic material in the designated region, which is less than the “maximum”); in other embodiments the “minimum” value is 0 (i.e., the substrate comprises no magnetic particles in the designated region).

The exact amount of magnetic material associated with a given substrate (e.g., incorporated within the base material, incorporated within pores of the base material, and/or on one or more surfaces) can vary. Typically, there are some limitations on the low end as to the amount of magnetic material useful to effectively result in inductive heating of the substrate and, in turn, any catalyst composition(s) deposited thereon in response to an applied alternating electromagnetic field. Generally, the heating efficiency increases as the magnetic material concentration increases. However, there are some limits on the high end as to the amount of magnetic material that can be effectively incorporated within a substrate structure without significantly compromising the production of the substrate (e.g., by negatively affecting the ability of the composition to be extruded) or by significantly compromising any physical properties of the resulting substrate (e.g., strength).

The form of the substrate produced according to the present disclosure can vary, such as a monolithic flow-through substrate having a plurality of fine, parallel gas flow passages extending from an inlet to an outlet face of the substrate such that passages are open to fluid flow. The passages, which are essentially straight paths from the inlet to the outlet, are defined by walls on which the catalytic material is coated as a washcoat so that the gases flowing through the passages contact the catalytic material. The flow passages of the monolithic substrate are thin-walled channels which can be of any suitable cross-sectional shape, such as trapezoidal, rectangular, square, sinusoidal, hexagonal, oval, circular, and the like. Such structures may contain from about 60 to about 1200 or more gas inlet openings (i.e., “cells”) per square inch of cross section (cpsi), more usually from about 300 cpsi to 600 cpsi. The wall thickness of flow-through substrates can vary, with a typical range being between 0.002 inches and 0.1 inches. A representative commercially-available flow-through substrate is a cordierite substrate having 400 cpsi and a wall thickness of 6 mil, or 600 cpsi and a wall thickness of 4 mil. However, it will be understood that the disclosed subject matter is not limited to a particular substrate type, material, or geometry.

In some embodiments, the substrate may be a wall-flow substrate, wherein each passage is blocked at one end of the substrate body with a non-porous plug, with alternate passages blocked at opposite end-faces. This requires that gas flow through the porous walls of the wall-flow substrate to reach the exit. Such monolithic substrates may contain up to about 700 or more cpsi, such as from about 100 cpsi to 400 cpsi and for example, from about 200 cpsi to about 300 cpsi. The cross-sectional shape of the cells can vary as described above. Wall-flow substrates typically have a wall thickness ranging from 0.002 inches and 0.1 inches. A representative commercially available wall-flow substrate is constructed from a porous cordierite, an example of which has 200 cpsi and 10 mil wall thickness or 300 cpsi with 8 mil wall thickness, and wall porosity between 40-70%. Other ceramic materials such as aluminum-titanate, silicon carbide and silicon nitride are also used as wall-flow filter substrates. However, it will be understood that the disclosed subject matter is not limited to a particular substrate type, material, or geometry. Note that where the substrate is a wall-flow substrate, the catalyst composition associated therewith (e.g., a CSF composition) can permeate into the pore structure of the porous walls (i.e., partially or fully occluding the pore openings) in addition to being disposed on the surface of the walls.

FIGS. 4A and 4B illustrate an exemplary catalyst 2 in the form of a flow-through substrate coated with a washcoat composition as described herein. Referring to FIG. 4A, the exemplary catalyst 2 has a cylindrical shape and a cylindrical outer surface 4, an upstream end face 6 and a corresponding downstream end face 8, which is identical to end face 6. Catalyst 2 has a plurality of fine, parallel gas flow passages 10 formed therein. As seen in FIG. 4B, flow passages 10 are formed by walls 12 and extend through carrier 2 from upstream end face 6 to downstream end face 8, the passages 10 being unobstructed so as to permit the flow of a fluid, e.g., a gas stream, longitudinally through carrier 2 via gas flow passages 10 thereof. As more easily seen in FIG. 4B, walls 12 are so dimensioned and configured that gas flow passages 10 have a substantially regular polygonal shape. As shown, the catalyst composition can be applied in multiple, distinct layers if desired. In the illustrated embodiment, the catalyst composition consists of both a discrete bottom layer 14 adhered to the walls 12 of the carrier member and a second discrete top layer 16 coated over the bottom layer 14. The present disclosure can be practiced with one or more (e.g., 2, 3, or 4) catalyst layers and is not limited to the two-layer embodiment illustrated in FIG. 4B.

Alternatively, FIG. 4A and FIG. 5 illustrate an exemplary substrate 2 in the form of a wall flow filter substrate coated with a washcoat composition. As seen in FIG. 5, the exemplary substrate 2 has a plurality of passages 22. The passages are tubularly enclosed by the internal walls 23 of the filter substrate. The substrate has an inlet end 24 and an outlet end 26. Alternate passages are plugged at the inlet end with inlet plugs 28, and at the outlet end with outlet plugs 30 to form opposing checkerboard patterns at the inlet 24 and outlet 26. A gas stream 32 enters through the unplugged channel inlet 34, is stopped by outlet plug 30 and diffuses through channel walls 23 (which are porous) to the outlet side 36. The gas cannot pass back to the inlet side of walls because of inlet plugs 28. The porous wall flow filter used in some embodiments is catalyzed in that the wall of said element has thereon or contained therein one or more catalytic materials. Catalytic materials may be present on the inlet side of the element wall alone, the outlet side alone, both the inlet and outlet sides, or the wall itself may be filled with all, or part, of the catalytic material. This disclosure includes the use of one or more layers of catalytic material that are within the wall or on the inlet and/or outlet walls of the element.

In some embodiments, the dispersion of magnetic material directly within the material of the substrate (e.g., flow through substrate or wall flow filter) or within pores of the substrate ensures that little to no blockage of passages that are designed to be open occurs. Further, this dispersion of the magnetic material, in some embodiments, can provide for substantially uniform heating of the substrate itself and the catalyst composition thereon when exposed to an electric field. Where the magnetic material is distributed throughout the entirety of the substrate (e.g., via dispersion throughout the base material or via containment within pores of the base material), this can allow for inductive heating of all surfaces of the substrate substantially uniformly, such that the catalyst composition thereon is heated substantially uniformly as well.

### Catalyst Composition

The catalyst composition coated on the substrate can vary without departing from the disclosed subject matter, and include any catalytically active materials commonly employed in emission control systems of, e.g., gasoline or diesel engines. For example, catalytically active materials can be a part of a composition adapted for one or more of oxidation of carbon monoxide, oxidation of hydrocarbons, oxidation of NOₓ, oxidation of ammonia, and selective catalytic reduction of NOₓ.

Such catalyst materials will typically include one or more catalytic metals impregnated or ion-exchanged in a porous support, with exemplary supports including refractory metal oxides and molecular sieves. In some embodiments, the catalytic metal is chosen from base metals, platinum group metals, oxides of base metals or platinum group metals, and combinations thereof. The catalytic material used in the disclosure can be described based on function and type, as well as materials of construction as noted above. For example, the catalyst material can be a diesel oxidation catalyst (DOC), a catalyzed soot filter (CSF), a lean NOₓ trap (LNT), a selective catalytic reduction (SCR) catalyst, an SCR catalyst on filter (SCRoF), an ammonia oxidation (AMOₓ) catalyst, or a three-way catalyst (TWC). Additional examples include catalytically active particles adapted for use as a volatile organic hydrocarbon (VOC) oxidation catalyst or a room temperature hydrocarbon oxidation catalyst.

A DOC or CSF catalyst typically comprises one or more PGM components impregnated on a metal oxide support such as alumina, optionally further including an oxygen storage component (OSC) such as ceria or ceria/zirconia, and typically provides oxidation of both hydrocarbons and carbon monoxide.

An LNT catalyst generally comprises one or more PGM components impregnated on a support and NOₓ trapping components (e.g., ceria and/or alkaline earth metal oxides). An LNT catalyst is capable of adsorbing NOₓ under lean conditions and reducing the stored NOₓ to nitrogen under rich conditions.

An SCR catalyst is adapted for catalytic reduction of nitrogen oxides with a reductant in the presence of an appropriate amount of oxygen. Reductants may be, for example, hydrocarbon, hydrogen, and/or ammonia. SCR catalysts typically comprise a molecular sieve (e.g., a zeolite) ion-exchanged with a promoter metal such as copper or iron, with exemplary SCR catalysts including FeBEA, FeCHA and CuCHA.

A TWC catalyst refers to the function of three-way conversion where hydrocarbons, carbon monoxide, and nitrogen oxides are substantially simultaneously converted. Typically, a TWC catalyst comprises one or more platinum group metals such as palladium and/or rhodium and optionally platinum, and an oxygen storage component. Under rich conditions, TWC catalysts typically generate ammonia.

An AMOₓ catalyst refers to an ammonia oxidation catalyst, which is a catalyst comprising one or more metals suitable to convert ammonia, and which is generally supported on a support material such as alumina or titania. An exemplary AMOₓ catalyst comprises a copper zeolite in conjunction with a supported platinum group metal (e.g., platinum impregnated on alumina).

Methods of making such catalyst compositions often involve impregnation of a porous support with a PGM or base metal solution and/or an ion-exchange process of molecular sieves with a metal precursor solution. Such methods and others known for making catalyst compositions that can be used in conjunction with the disclosed magnetic material-containing substrate are generally known in the art, e.g., as described in U.S. Pat. No. 9,138,732 to Bull et al and U.S. Pat. No. 8,715,618 to Trukhan et al., which are incorporated by reference therein in their entireties.

In some embodiments, the catalyst composition can comprise a magnetic material (in addition to the magnetic material contained within the substrate as disclosed herein), wherein the magnetic materials can be the same or different. See International Patent Application Publication No. WO2017/195107 to Yang et al., which is incorporated herein by reference in its entirety.

### Substrate Coating Process

The catalyst composition can be mixed with water (if in dried form) to form a slurry for purposes of coating a catalyst substrate. In addition to the catalyst particles, the slurry may optionally comprise alumina as a binder, associative thickeners, and/or surfactants (including anionic, cationic, non-ionic or amphoteric surfactants). In some embodiments, the pH of the slurry can be adjusted. e.g., to an acidic pH of about 3 to about 5. When present, an alumina binder is typically used in an amount of about 0.02 g/in³ to about 0.5 g/in³. The alumina binder can be, for example, boehmite, gamma-alumina, or delta/theta alumina.

The slurry can be milled to enhance mixing of the particles and formation of a homogenous material. The milling can be accomplished in a ball mill, continuous mill, or other similar equipment, and the solids content of the slurry may be, e.g., about 20 wt. %-60 wt. %, for example about 30 wt. %-40 wt. %. In one embodiment, the post-milling slurry is characterized by a D90 particle size of about 10 microns to about 50 microns (e.g., about 10 microns to about 20 microns). The D90 is defined as the particle size at which about 90% of the particles have a finer particle size.

The slurry is then coated on the catalyst substrate using a washcoat technique known in the art. As used herein, the term “washcoat” has its usual meaning in the art of a thin, adherent coating of a material applied to a substrate, such as a honeycomb flow-through monolith substrate or a filter substrate which is sufficiently porous to permit the passage therethrough of the gas stream being treated. As used herein and as described in Heck, Ronald and Robert Farrauto, Catalytic Air Pollution Control, New York: Wiley-Interscience, 2002, pp. 18-19, a washcoat layer includes a compositionally distinct layer of material disposed on the surface of a monolithic substrate or an underlying washcoat layer. A substrate can contain one or more washcoat layers, and each washcoat layer can have unique chemical catalytic functions.

In some embodiments, the substrate is dipped one or more times in the slurry or otherwise coated with the slurry. Thereafter, the coated substrate is dried at an elevated temperature (e.g., 100-150° C.) for a period of time (e.g., 1-3 hours) and then calcined by heating, e.g., at 400-600° C., typically for about 10 minutes to about 3 hours. Following drying and calcining, the final washcoat coating layer can be viewed as essentially solvent-free.

After calcining, the catalyst loading can be determined through calculation of the difference in coated and uncoated weights of the substrate. As will be apparent to those of skill in the art, the catalyst loading can be modified by altering the slurry rheology. In addition, the coating/drying/calcining process can be repeated as needed to build the coating to the desired loading level or thickness.

The catalyst composition can be applied as a single layer or in multiple layers. A catalyst layer resulting from repeated washcoating of the same catalyst material to build up the loading level is typically viewed as a single layer of catalyst. In another embodiment, the catalyst composition is applied in multiple layers with each layer having a different composition. Additionally, the catalyst composition can be zone-coated, meaning a single substrate can be coated with different catalyst compositions in different areas along the gas effluent flow path.

### Emission Treatment System

The present disclosure also provides an emission treatment system that incorporates the catalyst article described herein (wherein the substrate comprises a base material and a magnetic material). The catalyst article is typically used in an integrated emissions treatment system comprising one or more additional components for the treatment of gasoline or diesel exhaust gas emissions. As such, the terms “exhaust stream”, “engine exhaust stream”, “exhaust gas stream” and the like refer to the engine effluent as well as to the effluent downstream of one or more other catalyst system components as described herein.

The catalyst article comprising a substrate suitable for inductive heating as disclosed herein can be positioned at varying locations within the emission treatment system with respect to other components. In some embodiments, the disclosed catalyst article is coupled directly to the engine. The distance between the engine and catalyst article can be quite short resulting in a so-called “close coupled” catalytic arrangement. Alternatively, the distance from the engine to the catalyst can be longer, resulting in an “underfloor” configuration. The catalyst article disclosed herein can, alternatively, be positioned such that one or more other components are present between the engine and the catalyst article. For example, one or more other catalyst articles can be present upstream of the disclosed catalyst article. Similarly, one or more other catalyst articles can be present downstream of the disclosed catalyst article.

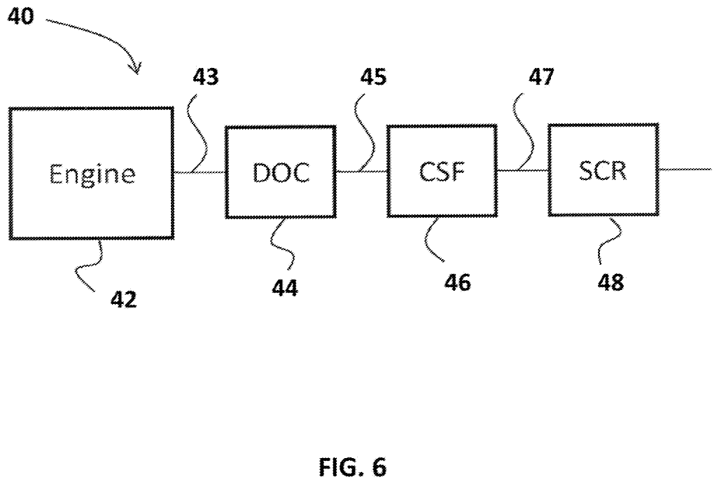

One exemplary emissions treatment system is illustrated in FIG. 6, which depicts a schematic representation of an emission treatment system 40. As shown, an exhaust gas stream comprising gaseous pollutants and particulate matter is conveyed via exhaust pipe 43 from an engine 42 to a diesel oxidation catalyst (DOC) 44. In the DOC 44, unburned gaseous and non-volatile hydrocarbons (i.e., the SOF) and carbon monoxide are largely combusted to form carbon dioxide and water. In addition, a proportion of the NO of the NOₓ component may be oxidized to NO₂ in the DOC. The exhaust stream is next conveyed via exhaust pipe 45 to a catalyzed soot filter (CSF) 46, which traps particulate matter present within the exhaust gas stream. The CSF 46 is optionally catalyzed for passive or active soot regeneration. After removal of particulate matter, via CSF 46, the exhaust gas stream is conveyed via exhaust pipe 47 to a downstream selective catalytic reduction (SCR) component 48 for the further treatment and/or conversion of NOₓ. Note that any or all of the above-noted catalyst components, or other optional catalyst components, could include the substrate disclosed herein, comprising the magnetic material. It is noted that the disclosure is not limited thereto; the principles disclosed herein are relevant to a range of different types of catalysts and can be employed in the context of a broad array of catalysts and associated emission treatment systems.

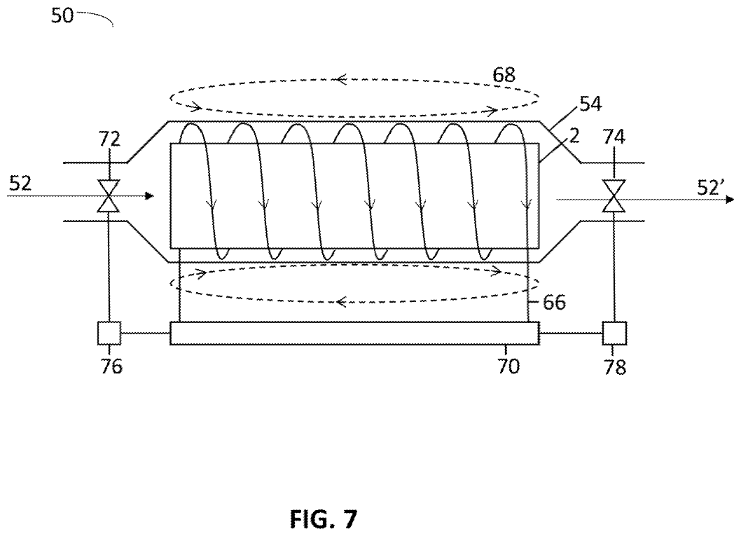

FIG. 7 provides a schematic view of an exemplary catalyst article 50, wherein arrows 52 and 52′ show the direction of travel of an engine effluent (52 indicating the gas entering the catalyst and 52′ indicating the gas exiting/treated by the catalyst). As shown, the catalyst article 50 includes a catalyst 2 enclosed in an exhaust pipe can 54. In the illustrated embodiment, catalyst 2 comprises a magnetic material as described herein. A wire coil 66 surrounds the catalyst 2 in order to provide an alternating magnetic field 68 adapted for inductive heating of the magnetic material within the substrate and this wire coil is attached to power source 70. It is noted that the depicted embodiment is not intended to be limiting of the coil construction. For example, in some embodiments, the coil does not comprise a single coil and, rather, comprises two or more individual coils. In some such configurations, the substrate may be surrounded on the front (upstream) end with one coil and on the back (downstream) end with another coil, optionally having a gap there between.

It is also noted that the depicted coil 66 wraps around the catalyst axially, such that the magnetic field is parallel to the gas flow. However, the disclosed system is not limited thereto. In some embodiments, the coil 66 (or multiple coils, as referenced above) can be placed laterally on the catalyst, such that the magnetic field generated thereby is transverse to the gas flow.

The wire coil 66 is electrically connected to a power source 70 capable of providing alternating electric current to the coil, with output power typically in the range from about 5 kW to 50 kW and at a frequency of about 1 kHz to about 1000 kHz (e.g., about 10 kHz to about 500 kHz). It is noted that the field strength may determine the extent to which the magnetic material within the substrate described herein can be magnetized. Note that the illustrated embodiment is merely one example of the disclosure. In alternative embodiments, the coil 66 could be placed in other locations such as also surrounding the catalyst can 54 or other catalyst components of the system. Also, the technology depicted in this figure can be applied to various types of emission catalysts and is not limited to any particular type of catalyst, including, but not limited to, the types of catalysts referenced herein (e.g., SCR, DOC, SCRoF, AMOₓ, and other catalysts).

The system 50 further includes an optional temperature sensor 72 positioned to measure the temperature of engine effluent gases entering the catalyst 2. Both the power source 70 and the temperature sensors 72 and 74 are operatively connected to controllers 76 and 78, which are configured to control the power source 70 and receive the temperature signals from the sensors. As would be understood, the controllers 76 and 78 can comprise hardware and associated software adapted to allow the controllers to provide instructions to the power source to energize the electric coil 66 at any time when inductive heating of the magnetic material is desired. The controllers can select the time period for inductive heating based on a variety of factors, such as based on a particular temperature set point associated with the temperature sensors 72 and/or 74, at specific time period based on ignition of the engine (e.g., a control system adapted to inductively heat the magnetic material for a set time period following engine ignition), or at specific preset time intervals.

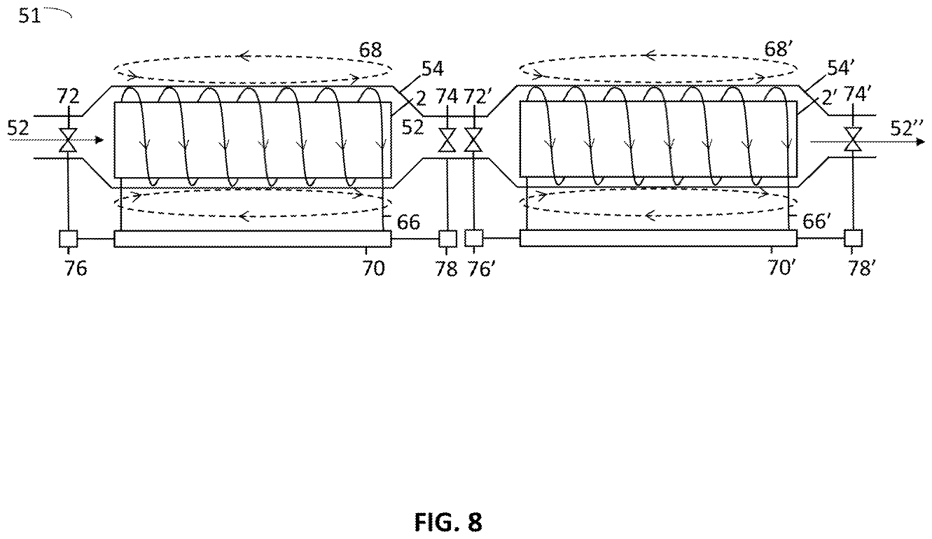

FIG. 8 illustrates system 51, which is a similar system to system 50, but employing more than one inductively heated catalyst article. Electric coils 66 and 66′ surround catalysts 2 and 2′ in order to provide alternating magnetic fields 68 and 68′ adapted for inductive heating of the magnetic material within the substrates. The system includes optional temperature sensors 72, 72′, 74, and 74′, which are operatively connected to controllers 76, 76′, 78 and 78′, respectively, configured to control the associated power sources 70 and 70′ and receive the temperature signals from the corresponding sensors. It is noted that, in some embodiments, there may be a single temperature controller in place of 74 and 72′ and, in such embodiments, that temperature sensor may be attached to and configured to control, both power sources 70 and 70′.

The magnetic material set forth herein can be added to any catalyst substrate for which inductive heating of a catalyst coating (or coatings) thereon would be useful to maintain the catalyst composition in an optimal temperature range for catalytic activity. The desired temperature range will vary depending on the catalyst type and function, but will typically be in the range of about 100° C. to 450° C., such as from about 150° C. to 350° C. In terms of specific, illustrative examples, an SCR catalyst will typically need to be heated to at least about 150° C. to promote useful SCR activity; a DOC catalyst will typically need to be heated to at least about 120° C. for useful CO oxidation; and an LNT typically needs to be heated to at least about 150° C. for useful NOₓ storage and at least about 250° C. for useful regeneration/NOₓ reduction.

### Non-Limiting Example Embodiments

Without limitation, some embodiments of the disclosure include:
1. A catalyst substrate, comprising: a) a ceramic material and b) a magnetic material, and
   wherein the magnetic material is capable of inductive heating in response to an applied alternating magnetic field.
2. The catalyst substrate of embodiment 1, wherein the magnetic material is contained within the ceramic material.
3. The catalyst substrate of embodiment 1, wherein the magnetic material is contained within pores of the ceramic material.
4. The catalyst substrate of any one of embodiments 1-3, wherein the magnetic material comprises an electrically insulating material.
5. The catalyst substrate of any one of embodiments 1-4, wherein the magnetic material comprises one or more metal oxides.
6. The catalyst substrate of embodiment 5, wherein the one or more metal oxides are chosen from transition metal oxides and rare earth metal oxides.
7. The catalyst substrate of embodiment 6, wherein the one or more metal oxides comprise one or more of oxides of lanthanum, cerium, neodymium, gadolinium, yttrium, praseodymium, samarium, hafnium, tungsten, manganese, iron, cobalt, nickel, copper, and zinc.
8. The catalyst substrate of any one of embodiments 1-7, wherein the magnetic material is in particulate form.
9. The catalyst substrate of any one of embodiments 1-8, wherein the ceramic material comprises cordierite, silicon carbide, or aluminum titanate.
10. The catalyst substrate of any one of embodiments 1-9, wherein the magnetic material is distributed substantially uniformly throughout the ceramic material.
11. The catalyst substrate of any one of embodiments 1-9, wherein the magnetic material is more concentrated within certain regions of the ceramic material.
12. The catalyst substrate of any one of embodiments 1-9, wherein the catalyst substrate comprises an inlet end and an outlet and, and wherein the magnetic material is more concentrated at the inlet end than at the outlet end or is more concentrated at the outlet end than at the inlet end.
13. The catalyst substrate of any one of embodiments 1-9, wherein the catalyst substrate is cylindrical with a radial center and a radial edge, and wherein the magnetic material is more concentrated at the radial center than at the radial edge or wherein the magnetic material is more concentrated at the radial edge than at the radial center.
14. The catalyst substrate of any one of embodiments 1-13, in the form of a monolithic flow-through substrate having an inlet end and an outlet end, and having a plurality of parallel gas passages extending from the inlet end to the outlet end, that are open to fluid flow.
15. The catalyst substrate of any one of embodiments 1-13, in the form of a wall-flow substrate having an inlet and an outlet end, and having a plurality of parallel gas passages extending from the inlet end to the outlet end, wherein a portion of the plurality of parallel gas passages are blocked at the inlet end and open at the outlet end and an alternate portion of the plurality of parallel gas passages are open at the inlet end and blocked at the outlet end.
16. A catalyst article, comprising a catalytic washcoat on the catalyst substrate of any one of embodiments 1-15.
17. The catalyst article of embodiment 16, wherein the catalytic washcoat comprises a catalytic material adapted for one or more of oxidation of carbon monoxide, oxidation of hydrocarbons, oxidation of NOₓ, reduction of NOₓ, oxidation of ammonia, selective catalytic reduction of NOₓ, NOₓ storage/reduction, oxygen storage, soot burning or oxidation, and water-gas-shift.
18. The catalyst article of embodiment 16 or 17, adapted for use as a diesel oxidation catalyst (DOC), a catalyzed soot filter (CSF), a lean NOₓ trap (LNT), a selective catalytic reduction (SCR) catalyst, an SCR catalyst on filter (SCRoF), an ammonia oxidation (AMOₓ) catalyst, a NOₓ absorber, or a three-way catalyst (TWC).
19. A system, comprising:
   the catalyst article of any one of embodiments 16-18 comprising:
   a conductor for receiving current and generating an alternating electromagnetic field in response thereto, and
   wherein the conductor is positioned such that the generated alternating electromagnetic field is applied to at least a portion of the magnetic material.
20. The system of embodiment 19, wherein the conductor is in the form of at least one coil of conductive wire surrounding at least a portion of the catalyst article.
21. The system of embodiment 19, further comprising an electric power source electrically connected to the conductor for supplying alternating current thereto.
22. The system of embodiment 19, further comprising a temperature sensor positioned to measure the temperature of gases entering the catalyst article and a controller in communication with the temperature sensor, the controller adapted for control of the current received by the conductor such that the controller can energize the conductor with current when inductive heating of the catalyst substrate is desired.
23. A method of treating emissions from an internal combustion engine, comprising:
   treating exhaust gas produced from an internal combustion engine with an emission treatment system, the emission treatment system comprising the system of any one of embodiments 19-22.
24. The method of embodiment 23, wherein the internal combustion engine is a gasoline engine, diesel engine, hybrid electric, or natural gas engine.

### EXAMPLES

Aspects of the disclosed subject matter will be further described with reference to specific examples. These examples are merely representative of the myriad of embodiments possible which fall within the scope of the disclosure and should not be taken as limiting the disclosure.

### Example 1: Activation of a Flow-Through Substrate

In a representative preparation, 173 g nickel-zinc ferrite powder was combined with 248 g DI water. Then 21 g dispersible aluminum oxide was added, and the resulting suspension was mixed under high-shear conditions to homogenize. Finally, 33 g of solution of 30% zirconium oxide dissolved in acetic acid was added to the suspension and the pH was adjusted to 6.5 using monoethanolamine. The suspension was milled in a ceramic ball mill until the particle size distribution showed a D90 near 11 mm. A porous ceramic honeycomb flow-through substrate having a square-prismatic shape with dimensions 10.1 mm×10.1 mm×76 mm, a channel density=300 cpsi, and wall thickness of 8 mil, was dipped into this slurry until the part was saturated. The part was removed from the slurry, and excess slurry was drained. The remaining slurry was distributed with an air jet through the part. The resulting wet ceramic piece was dried in a flow of air at 120° C., followed by calcination at 550° C. for one hour in air. This procedure yielded a nominal loading of nickel-zinc ferrite on the part of 1.0 g/in³ substrate volume. The dipping, drying, and calcination procedure was repeated with five different substrate parts.

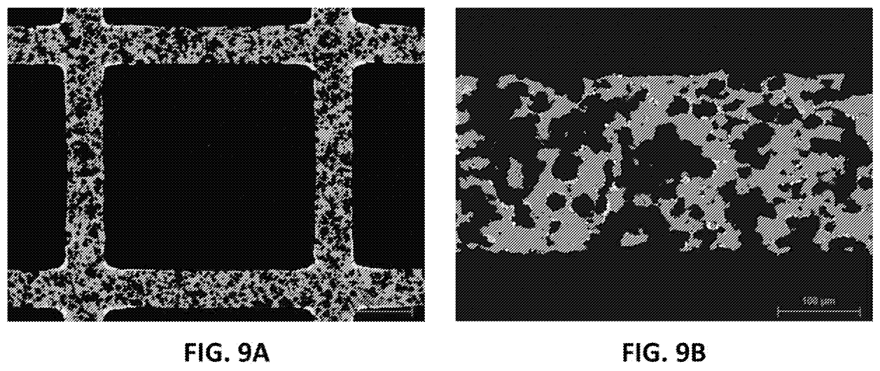

FIG. 9A shows a low-magnification SEM image of the resulting activated substrate in cross section viewed down the channel axis. The gray areas are the ceramic substrate and the bright areas show the location of nickel-zinc ferrite. The low-magnification image indicates that at least a portion of the nickel-zinc ferrite resides on the surface of the porous substrate, especially in the corners of the channels. FIG. 9B shows a high-magnification SEM image of the activated substrate also viewed down the channel axis. This image shows that a substantial fraction of the nickel-zinc ferrite has permeated into the internal void space of the channel walls.

### Example 2: Activation of a Filter Substrate

The slurry prepared in Example 1 was also used to activate a ceramic substrate in “filter mode.” This means that alternating channels were plugged with ceramic paste in the inlet end of the ceramic substrate. The remaining fully open channels were plugged with ceramic paste at the outlet end. In this configuration, the only flow path from one end of the substrate to the other passes through the pores in the channel walls. A ceramic honeycomb substrate of this type having a square-prismatic shape with dimensions 10.1 mm×10.1 mm×114 mm, a channel density of 300 cpsi, and wall thickness of 8 mil, was dipped into this slurry until the part was saturated. The part was removed from the slurry, and excess slurry was drained. The remaining slurry was distributed with an air jet through the part. The resulting wet ceramic piece was dried in a flow of air at 120° C., followed by calcination at 550° C. for one hour in air. This procedure yielded a nominal loading of nickel-zinc ferrite on the part of 1.0 g/in³ substrate volume. The dipping, drying, and calcination procedure was repeated with five different substrate parts.

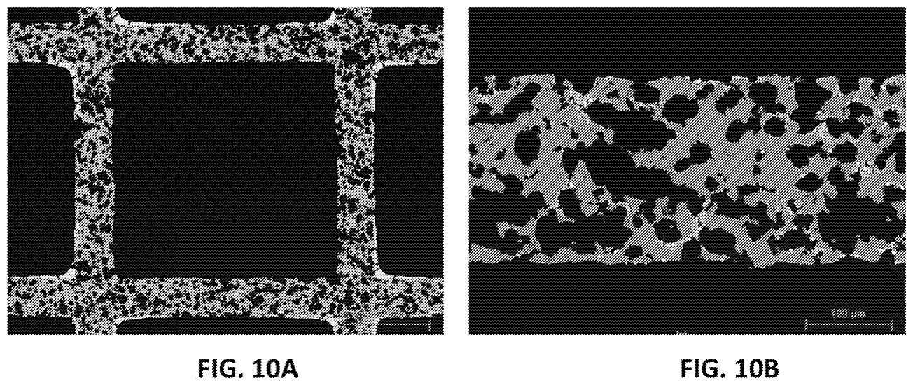

FIG. 10A shows a low-magnification SEM image of the resulting activated substrate in cross section viewed down the channel axis. The gray areas are the ceramic substrate and the bright areas show the location of nickel-zinc ferrite. The low-magnification image indicates that at least a portion of the nickel-zinc ferrite resides on the surface of the porous substrate, especially in the inlet channel of the filter substrate. FIG. 10B shows a high-magnification SEM image of the activated substrate also viewed down the channel axis. This image shows that a substantial fraction of the nickel-zinc ferrite has permeated into the internal void space of the channel walls as well.

Evaluation of the activated ceramic substrates for magnetic induction heating.

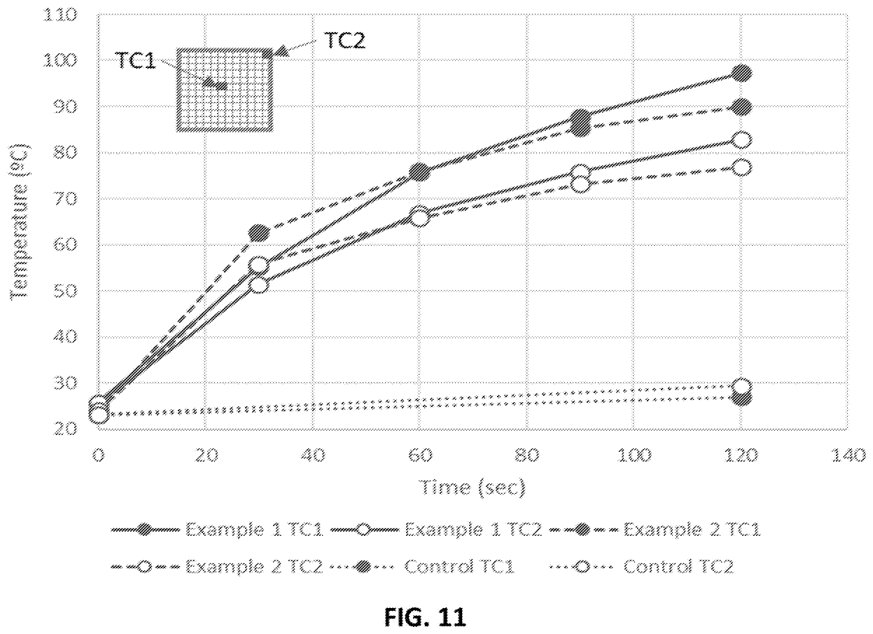

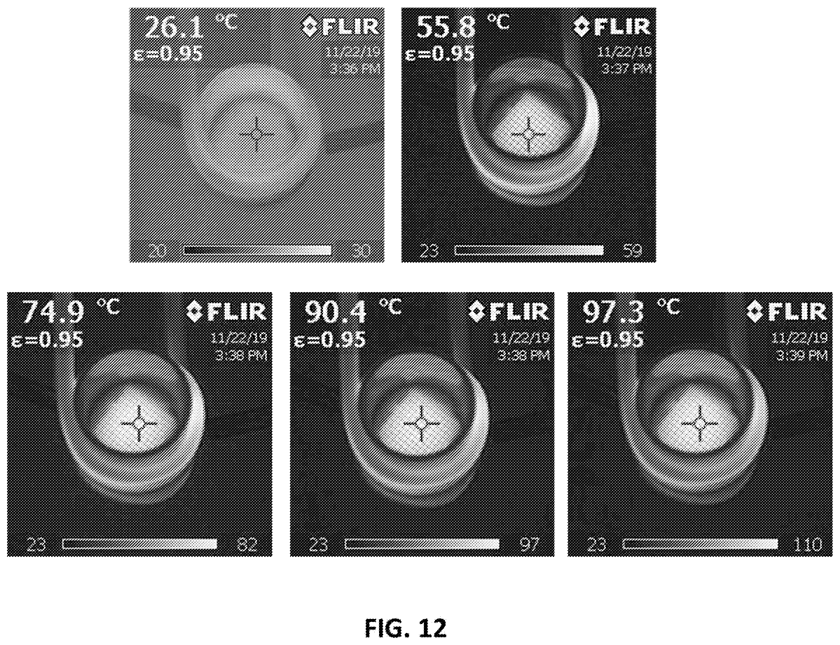

A sample from each set of activated substrates produced in Examples 1 and 2 was selected and cut to a length of 25 mm. The 25 mm long segments were wrapped in a flexible ceramic tape to form a matte and inserted into a 25 mm OD glass tube. The glass tube assembly was mounted inside a 10 gauge wire core with OD of 33 mm. The coil was 44 mm long and contained 7 complete turns of wire. An AC potential of 26 V (peak) oscillating at 53 kHz was applied using an AC power supply designed for operation of induction heating coils. The ceramic sample was centered along the axis of the coil. Two thin K-type thermocouples were inserted into substrate channels at positions indicated as TC1 and TC2 in FIG. 11, inset. The thermocouples were longitudinally centered in the channels. Application of the AC potential across the coil gave a temperature increase with time at TC1 and TC2, as shown in FIG. 11. The data show that the rate of temperature increase is effectively the same for the substrates coated in flow-thru and filter modes. The thermocouple placed at the edge of the part (TC2) shows somewhat lower temperature than in the center (TC1), but the heating appears generally uniform across the face of the part. This can be seen even more easily in the series of infrared thermal images in FIG. 12, which were collected every 30 seconds during evaluation of Example 2. The images show that the part is heated uniformly across the sample cross-section over the course of 2 min. A control sample consisting of a substrate without activation by nickel-zinc ferrite showed no increase in temperature at either TC position. This demonstrates that the magnetic material is a functional requirement for achieving heating by magnetic induction.

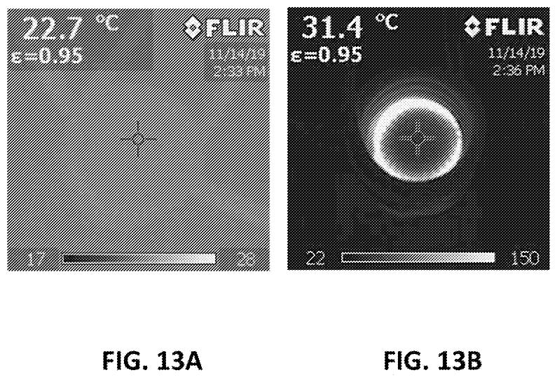

The uniformity in heating achieved for Examples 1 and 2 is understood to be a consequence of the fact that the active magnetic particles are distributed throughout the ceramic part, and that each particle is heated independently. The physical mechanism by which the magnetic particles are heated is based on magnetic hysteresis loss, and it is fundamentally different from classical induction heating of conductive materials. To demonstrate this difference, a cylindrical metal substrate with 24 mm OD was mounted in the induction coil. Application of the same AC potential as used for the ceramic parts above yielded a highly inhomogeneous thermal profile as shown by the thermal images in FIG. 13. The metallic substrate is also heated, but only at the outer rim of the part. The center of the part can be heated only by thermal conduction from the outer rim. This is a manifestation of the electrical “skin effect” well-known in the design of AC circuits. If reflects that fact that heat is generated by eddy currents induced in the conductive part, but these eddy currents are highly localized on the outer rim of the conductor.

While the subject matter herein disclosed has been described by means of specific embodiments and applications thereof, numerous modifications and variations could be made thereto by those skilled in the art without departing from the scope of the disclosure set forth in the claims. Furthermore, various aspects of the disclosure may be used in other applications than those for which they were specifically described herein.

1. A catalyst substrate, comprising:
a) a ceramic material and
b) a magnetic material, and
wherein the magnetic material is capable of inductive heating in response to an applied alternating magnetic field.

2. The catalyst substrate of claim 1, wherein the magnetic material is contained within the ceramic material.

3. The catalyst substrate of claim 1, wherein the magnetic material is contained within pores of the ceramic material.

4. The catalyst substrate of claim 1, wherein the magnetic material comprises an electrically insulating material.

5. The catalyst substrate of claim 1, wherein the magnetic material comprises one or more metal oxides selected from transition metal oxides and rare earth metal oxides.

6. (canceled)

7. The catalyst substrate of claim 5, wherein the one or more metal oxides comprise one or more of oxides of lanthanum, cerium, neodymium, gadolinium, yttrium, praseodymium, samarium, hafnium, tungsten, manganese, iron, cobalt, nickel, copper, and zinc.

8. The catalyst substrate of claim 1, wherein the magnetic material is in particulate form.

9. The catalyst substrate of claim 1, wherein the ceramic material comprises one or more of cordierite, silicon carbide, or aluminum titanate.

10. The catalyst substrate of claim 1, wherein the magnetic material is distributed substantially uniformly throughout the ceramic material.

11. The catalyst substrate of claim 1, wherein the magnetic material is more concentrated within certain regions of the ceramic material.

12. The catalyst substrate of claim 1, wherein the catalyst substrate comprises an inlet end and an outlet and, and wherein the magnetic material is more concentrated at the inlet end than at the outlet end, or is more concentrated at the outlet end than at the inlet end.

13. The catalyst substrate of claim 1, wherein the catalyst substrate is cylindrical with a radial center and a radial edge, and wherein the magnetic material is more concentrated at the radial center than at the radial edge, or wherein the magnetic material is more concentrated at the radial edge than at the radial center.

14. The catalyst substrate of claim 1, wherein the catalyst substrate is in a form of a monolithic flow-through substrate having an inlet end and an outlet end, and having a plurality of parallel gas passages extending from the inlet end to the outlet end, that are open to fluid flow.

15. The catalyst substrate of claim 1, wherein the catalyst substrate is in a form of a wall-flow substrate having an inlet and an outlet end, and having a plurality of parallel gas passages extending from the inlet end to the outlet end, wherein a portion of the plurality of parallel gas passages are blocked at the inlet end and open at the outlet end and an alternate portion of the plurality of parallel gas passages are open at the inlet end and blocked at the outlet end.

16. A catalyst article, comprising a catalytic washcoat on the catalyst substrate of claim 1.

17. The catalyst article of claim 16, wherein the catalytic washcoat comprises a catalytic material adapted for one or more of oxidation of carbon monoxide, oxidation of hydrocarbons, oxidation of NOₓ, reduction of NOₓ, oxidation of ammonia, selective catalytic reduction of NOₓ, NOₓ storage/reduction, oxygen storage, soot burning or oxidation, and water-gas-shift.

18. The catalyst article of claim 16, wherein the catalyst substrate is adapted for use as a diesel oxidation catalyst (DOC), a catalyzed soot filter (CSF), a lean NOₓ trap (LNT), a selective catalytic reduction (SCR) catalyst, an SCR catalyst on filter (SCRoF), an ammonia oxidation (AMOₓ) catalyst, a NOₓ absorber, or a three-way catalyst (TWC).

19. A system, comprising:
the catalyst article of claim 16; and
a conductor for receiving current and generating an alternating electromagnetic field in response thereto, and the conductor is positioned wherein the generated alternating electromagnetic field is applied to at least a portion of the magnetic material.

20. The system of claim 19, wherein the conductor is in a form of at least one coil of conductive wire surrounding at least a portion of the catalyst article.

21. The system of claim 19, further comprising an electric power source electrically connected to the conductor for supplying alternating current thereto.

22. The system of claim 19, further comprising a temperature sensor positioned to measure a temperature of gases entering the catalyst article and a controller in communication with the temperature sensor, and the controller controls the current received by the conductor wherein the controller energizes the conductor with current when inductive heating of the catalyst substrate is desired.

23. A method of treating emissions from an internal combustion engine, comprising:
treating exhaust gas produced from an internal combustion engine with an emission treatment system, wherein the emission treatment system comprising the system of claim 19.

24. The method of claim 23, wherein the internal combustion engine is a gasoline engine, diesel engine, hybrid electric, or natural gas engine.
